(19) United States
(12) Patent Application Publication
(10) Pub. No.: US 2021/0213479 A1
(43) Pub. Date: Jul. 15, 2021

(54) SYSTEM AND METHOD FOR APPLYING A VIBRATION TO A CONTAINER HELD BY AN END EFFECTOR

(71) Applicant: 9958304 Canada Inc. (YPC Technologies), Montreal (CA)

(72) Inventor: Gunnar Grass, Montreal (CA)

(21) Appl. No.: 16/743,744

(22) Filed: Jan. 15, 2020

(51) Int. Cl. B05B 17/00; B25J 13/08; B25J 15/00; B06B 1/16

(52) U.S. Cl. CPC B05B 17/0638; B25J 13/087; B25J 19/023; B06B 1/161; B25J 13/085; B25J 15/0028

(57) ABSTRACT

A system and a method are disclosed for applying a vibration to a container comprising a content, said container held by an end effector attached to a mechatronic manipulator, the system comprising a vibration generator operatively coupled to at least one of the end effector and the mechatronic manipulator at an operating distance from the container such that when said vibration generator is in operation, said vibration generator causes said container to vibrate accordingly and a controller operatively connected to the vibration generator, the controller for generating and providing a controlling signal to the vibration generator.

### FIELD

One or more embodiments of the invention relates to robotics. More precisely, one or more embodiments of the invention pertains to a system and a method for applying a vibration to a container held by an end effector.

### BACKGROUND

Robots are more and more present. They bring many advantages by being able to bring automation to certain repetitive tasks for instance.

While they clearly bring many advantages, the use of robots also brings its challenges, especially when robots are trying to mimic complex movements associated with a task which can be, ironically, very easily achieved by humans.

For instance, one of these tasks is the dispensing of a content contained in a container. The skilled addressee will appreciate that a robot holding a container has indeed very few controls in the dispensing operation of the content comprised in the container. The main controlling parameter used by a robot arm holding a container is indeed the angle of inclination of the container around an horizontal axis. As a consequence, the robot has a limited control on many parameters of the dispensing task, such as, for instance, a dispensing flow rate. In other terms it can be difficult to control a dispensing flow rate. This is clearly a serious limitation in many fields where a precise dispensing flow rate has to be achieved. This can be the case for instance in the field of cooking using robots or in the field of pharmaceutical manufacturing just to name a few.

The problem of controlling a dispensing is even furthermore complex in the case where the content of the container is comprised of elements of various sizes and shapes.

There is a need for at least one of a method and a system for enabling a dispensing of a content of a container that will overcome at least one of the above-identified drawbacks.

Features of the one or more embodiments of the invention will be apparent from review of the disclosure, drawings and description of the invention below.

### BRIEF SUMMARY

According to a broad aspect, there is disclosed a system for applying a vibration to a container comprising a content, said container held by an end effector attached to a mechatronic manipulator, the system comprising a vibration generator operatively coupled to at least one of the end effector and the mechatronic manipulator at an operating distance from the container such that when said vibration generator is in operation, said vibration generator causes said container to vibrate accordingly; and a controller operatively connected to the vibration generator, said controller for generating and providing a controlling signal to said vibration generator.

According to an embodiment, the applying of the vibration according to the controlling signal is used for performing a dispensing operation of at least one part of the content of the container.

According to an embodiment, the dispensing operation to be performed is one of starting a dispensing of the content and dispensing the content according to a given flow rate.

According to an embodiment, the vibration generator is selected from a group comprising at least one of a vibration motor, an ultrasonic motor, a piezo electric actuator and an ultrasonic transducer.

According to an embodiment, the vibration generator comprises a vibration motor comprising a motor having a rotating axis and a mass eccentrically mounted on said axis of said motor.

According to an embodiment, the controlling signal causes said vibration generator to vibrate at a given vibrating frequency suitable for said dispensing operation to be performed.

According to an embodiment, the controlling signal causes said vibration generator to vibrate at a given amplitude suitable for said given dispensing operation to be performed.

According to an embodiment, the system further comprises a vibration sensor operatively connected to the controller, the vibration sensor providing a vibration sensor signal to the controller, further wherein the controlling signal is generated using the vibration sensor signal and the dispensing operation to be performed.

According to an embodiment, the vibration generator comprises at least two vibration generating units, each of the at least two vibration generating units generating a corresponding vibration; further wherein the controlling signal comprises at least two corresponding vibration generating unit controlling signals for controlling each of the at least two corresponding vibration generating units accordingly.

According to an embodiment, the system further comprises a vibration sensor operatively connected to the controller, said vibration sensor providing a vibration sensor signal to the controller, further wherein the controlling signal is generated using the vibration sensor signal and the dispensing operation to be performed.

According to an embodiment, each of the at least one corresponding vibration generating unit controlling signal causes the corresponding vibration generating unit to vibrate at a given vibrating frequency suitable for said dispensing operation to be performed.

According to an embodiment, each of the at least two corresponding vibration generating unit controlling signals causes the corresponding vibration generating unit to vibrate at a given amplitude suitable for said given dispensing operation to be performed.

According to an embodiment, the vibration generator is mounted on the mechatronic manipulator at an end effector.

According to an embodiment, the end effector is a robotic gripper.

According to an embodiment, the end effector is a robotic gripper comprising at least one finger used for holding the container and the vibration generator is mounted on a finger of the at least one finger.

According to an embodiment, the controller comprises a lookup table comprising for each dispensing operation to be performed a corresponding controlling signal to provide, wherein the generating of the controlling signal comprises accessing the lookup table.

According to an embodiment, the system further comprises a dispensing feedback device operatively connected to the controller, the dispensing feedback device providing a signal indicative of a content dispensed, the controller generating the controlling signal according to the dispensing operation to be performed and using the signal indicative of a content dispensed.

According to an embodiment, the dispensing feedback device is selected from a group consisting of a camera, a load cell and a torque sensor.

According to an embodiment, at least two of the at least two vibration generating units are mounted in different directions.

According to a broad aspect, there is disclosed a method for applying a vibration on a container comprising a content, said container being held by an end effector attached to a mechatronic manipulator, the method comprising obtaining an indication of a vibration to generate; determining a controlling signal suitable for the obtained indication of a vibration to generate; providing the determined controlling signal to a vibration generator operatively coupled to at least one of the end effector and the mechatronic manipulator at an operating distance from the container such that when said vibration generator is in operation, said vibration generator causes said container to vibrate accordingly.

According to an embodiment, the vibration is used for performing a dispensing operation, further wherein said indication of a vibration is suitable for the dispensing operation to perform.

According to an embodiment, the method further comprises obtaining a feedback indicative of a content dispensed, the method further comprising amending the controlling signal using the obtained feedback indicative of a content dispensed.

According to an embodiment, the determining of the controlling signal suitable for the obtained dispensing operation to perform comprises accessing a lookup table with an indication of the dispensing operation to perform and obtaining a corresponding controlling signal.

According to an embodiment, there is disclosed a mechatronic manipulator comprising the system as disclosed above.

According to an embodiment, there is disclosed a computer readable medium comprising computer executable instructions which when executed causes a processing unit to perform the method as disclosed above.

An advantage of one or more embodiments of the method disclosed is that it enables a more precise dispensing of a content contained in a container when the method is used for dispensing the content of the container.

Another advantage of one or more embodiments of the method disclosed is that it enables a filtering of a content contained in a container when the content is comprised of a plurality of granular elements of various sizes.

Another advantage of one or more embodiments of the method disclosed is that it enables a precise and slower dispensing of a content contained in a container when the method is used for dispensing the content of the container.

Another advantage of one or more embodiments of the method disclosed is that it enables to start and stop the dispensing of a content contained in a container with openings on the bottom when the method is used for dispensing the content of the container.

Another advantage of one or more embodiments of the method disclosed is that it enables the sorting of a content contained in a container according to particle size when the content is comprised of a plurality of granular elements of various sizes.

Another advantage of one or more embodiments of the method disclosed herein is that it enables to achieve a more continuous flow rate enabling a greater predictability and control throughout the dispensing process.

### BRIEF DESCRIPTION OF THE DRAWINGS

In order that the invention may be readily understood, embodiments of the invention are illustrated by way of example in the accompanying drawings.

FIG. 1 is a diagram which illustrates a robotic system comprising an embodiment of a system for applying a vibration to a container to be held by the robotic system.

FIG. 2 is a diagram which shows a partly exploded view of an embodiment of an end effector of the robotic system comprising an embodiment of a vibration generator of a system for applying a vibration to a container.

FIG. 3 is a diagram which shows a symbolic, partly exploded, view of an embodiment of an end effector of the robotic system comprising an embodiment of a vibration generator of a system for applying a vibration to a container.

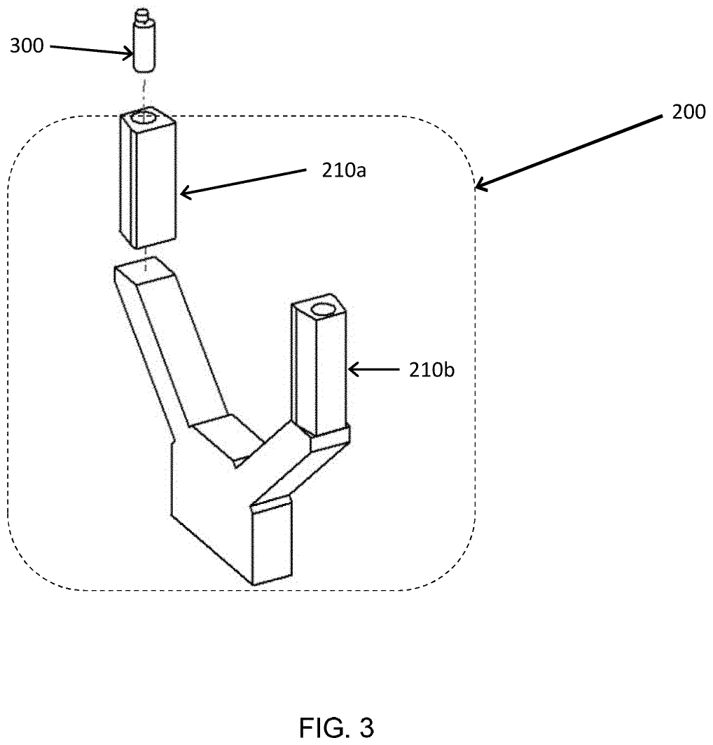

FIG. 4a is a diagram which shows a front perspective view of an embodiment of a vibration generator while FIG. 4b is a diagram which shows a top view of the embodiment of the vibration generator shown in FIG. 4a.

FIG. 5 is a diagram which shows a side elevation view illustrating an embodiment of an end effector incorporating a vibration generator.

FIG. 6 is a diagram which shows a side elevation view illustrating an end effector incorporating two vibration generators as well as a vibration sensor.

FIG. 7 is a diagram which shows a side elevation view illustrating the end effector incorporating two vibration generators and the vibration sensor; wherein the vibration generators are capable of generating vibrations at different amplitudes.

FIG. 8 is a diagram which shows a side elevation view illustrating an end effector operatively coupled to the manipulator.

FIG. 9a is a cross section view illustrating a container to be held by an end effector of a robotic system wherein the container comprises a content in an embodiment wherein no vibration is applied; FIG. 9b illustrates the container of FIG. 9a in the case wherein a vibration is being applied.

FIGS. 10a, b, c and d illustrate each a given angle of a dispensing sequence of a container to be held by an end effector of a robotic system in the case wherein no vibration is applied to the container.

FIGS. 11a, b, c and d illustrate each a given angle of a dispensing sequence of a container to be held by an end effector of a robotic system in the case wherein a vibration is applied to the container using the system for applying a vibration to a container.

FIGS. 12a and 12b are diagrams which illustrate a first alternative application of the method for applying a vibration to a container to be held by an end effector of a robotic system. In FIG. 12a no vibration is applied yet on the container. In FIG. 12b a vibration has been applied to the container to be held by an end effector of a robotic system using the system for applying a vibration to a container.

FIGS. 13a and 13b are diagrams which illustrate a second alternative application of the method for applying a vibration to a container to be held by an end effector of a robotic system. In FIG. 13a no vibration is applied yet on the container. FIG. 13b illustrates the effect of applying a vibration to the container.

FIG. 14 is a flowchart which shows an embodiment of a method for applying a vibration to a container comprising a content.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, one or more embodiments of the present invention is directed to a system and a method for applying a vibration to a container held by an end effector attached to a mechatronic manipulator and its use for various applications.

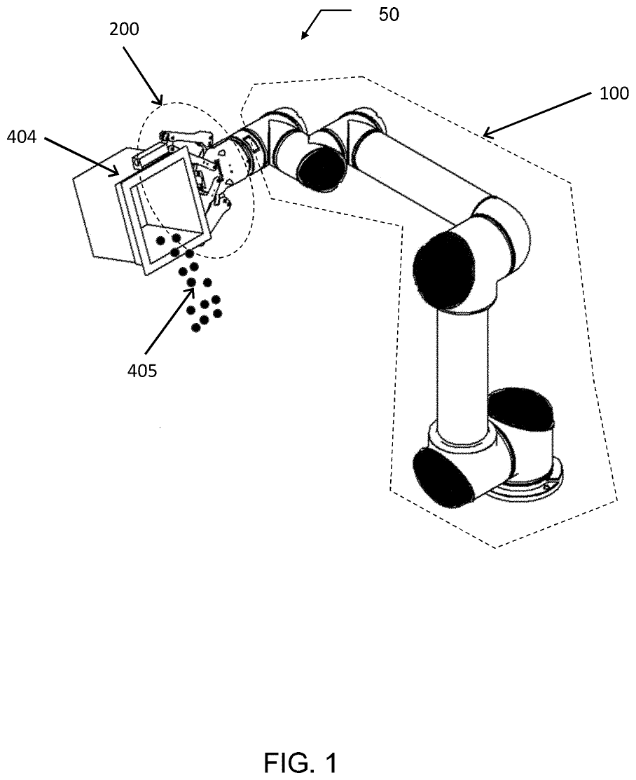

Now referring to FIG. 1, there is shown an embodiment of a robotic system 50 comprising an embodiment of a system for applying a vibration to a container.

The robotic system 50 comprises, inter alia, a mechatronic manipulator 100 and an end effector 200. A container 404 comprising a content 405 is held by the end effector 200 of the robotic system 50.

It will be appreciated that the mechatronic manipulator 100 is operatively coupled to the end effector 200.

The skilled addressee will appreciate that the mechatronic manipulator 100 may be of various types. For instance and in accordance with one embodiment, the mechatronic manipulator 100 is a six-axis robotic arm and is manufactured by Universal Robots. In another embodiment, the mechatronic manipulator 100 is a Cartesian robot and is manufactured by Yamaha Motor. In another embodiment, the mechatronic manipulator 100 is a SCARA robot and is manufactured by Epson. The skilled addressee will appreciate that various alternative embodiments may be provided for the mechatronic manipulator 100.

Moreover, it will be appreciated that the end effector 200 is sized and shaped for holding the container 404.

The skilled addressee will appreciate that the end effector 200 may be of various types depending for instance on the container to be held. In one embodiment, the end effector 200 is a robotic gripper manufactured by Robotiq. In another embodiment, the end effector 200 is a vacuum gripper and is manufactured by Coval. In another embodiment, the end effector 200 is a magnetic gripper and is manufactured by SMC Corporation of America. The skilled addressee will appreciate that various alternative embodiments may be provided for the end effector 200.

Still referring to FIG. 1, it will be appreciated that the container 404 may be of various size and shape. Moreover, it will be appreciated that the container 404 may be made of various materials, known to the skilled addressee. In one embodiment, the container 404 is a container with a single large opening on the top, an embodiment of which is a gastronorm container of size GN1/6 and is manufactured by Cambro. In another embodiment, the container 404 is a pharmaceutical plastic bottle and is manufactured by Amcor Limited. The skilled addressee will appreciate that various alternative embodiments may be provided for the container 404.

Still referring to FIG. 1, it will be appreciated that the container 404 is sized and shaped for receiving the content 405. The skilled addressee will appreciate that the content 405 may be of various types and that the container 404 is suitable for such content. In one embodiment, the content 405 is a solid content made of solid elements or particles. It will be appreciated that the solid elements may be of various size and shapes depending on an application sought. For instance and in a non-limiting embodiment, the content 405 of the container 404 comprises a powder. In another embodiment, the content 405 of the container 404 comprises granular elements of various sizes and shapes. In another embodiment, the content 405 of the container 404 comprises fluids of various viscosities. In another embodiment, the content 405 of the container 404 comprises a highly viscous fluid with enclosed gas bubbles. The skilled addressee will appreciate that many embodiments may be provided for the content 405 of the container 404 depending on an application sought.

While this is not visible on FIG. 1, it will be appreciated that a system is further disclosed for applying a vibration to the container 404 comprising the content 405.

The system comprises a vibration generator operatively coupled to at least one of the end effector 200 and the mechatronic manipulator 100 at an operating distance from the container 404 such that when the vibration generator is in operation, the vibration generator causes the container 404 to vibrate accordingly.

The system further comprises a controller operatively connected to the vibration generator. The controller is used for generating and providing a controlling signal to the vibration generator.

It will be appreciated that the controller may be located at various places. For instance, the controller may be located in the end effector 200 in one embodiment. In another embodiment, the controller is located in the mechatronic manipulator 100. In another alternative embodiment, the controller is located outside the robotic system 50.

Moreover it will be appreciated that the controller may be of various types. In one embodiment, the controller is selected from a group consisting of micro-controllers, FPGAs, dedicated circuits, etc.

It will be appreciated that the system disclosed herein may be used for various applications as explained below.

In fact and in one embodiment, the system is used when performing a dispensing operation of at least one part of the content 405 of the container 404. It will be appreciated that the controlling signal provided by the controller causes the vibration generator to vibrate at a given vibrating frequency suitable for the dispensing operation.

In one embodiment, the dispensing operation to be performed is one of starting a dispensing of the content 405 and dispensing the content according to a given flow rate.

It will be appreciated that in one embodiment, the controller further comprises a lookup table comprising for each dispensing operation to be performed a corresponding controlling signal to provide. In such embodiment, the generating of a controlling signal comprises accessing the lookup table and obtaining a corresponding controlling signal to provide.

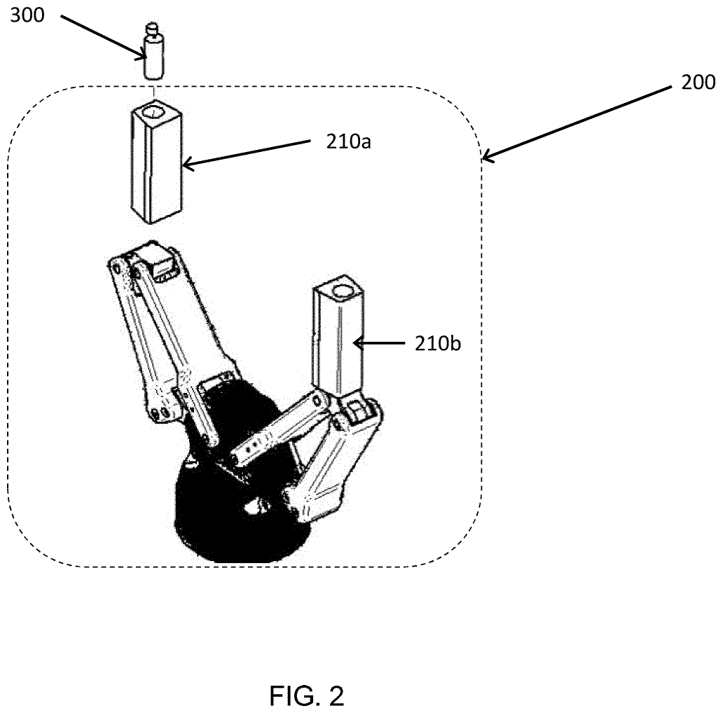

Now referring to FIG. 2, there is shown a partly exploded view of an embodiment of an end effector 200 used in a robotic system comprising an embodiment of the system for applying a vibration to a container 404.

More precisely, the end effector 200 is a robotic gripper comprising at least one finger used for holding the container 404. It will be appreciated that in this specific embodiment, the system for applying a vibration to the container 404 comprises a vibration generator 300 which is operatively coupled to the end effector 200. More precisely and in this specific embodiment, the vibration generator 300 is mounted inside a first finger 210a of the at least one finger of the end effector 200.

It will be appreciated that in this embodiment, the at least one finger of the end effector 200 comprises the first finger 210a as well as a second finger 210b.

The skilled addressee will further appreciate that each of the first finger 210a and the second finger 210b is sized and shaped for holding a corresponding portion of the container 404. It will be further appreciated by the skilled addressee that various embodiments may be provided for the first finger 210a and the second finger 210b.

Still referring to the embodiment disclosed in FIG. 2, it will be appreciated that the first finger 210a comprises a cavity sized and shaped for receiving and snuggly holding the vibration generator 300. It will be appreciated that in this embodiment, and when in operation, the vibration generator 300 causes the container 404 to vibrate accordingly.

It will be further appreciated that the vibration generator 300 may be of various types.

In fact, it will be appreciated that the vibration generator 300 is selected from a group comprising at least one of a vibration motor, an ultrasonic motor, a piezo electric actuator and an ultrasonic transducer.

In one embodiment, the vibration generator 300 comprises a vibration motor.

While there is illustrated an embodiment wherein the end effector 200 comprises two fingers, it will be appreciated by the skilled addressee than in alternative embodiment any number of finger may be used. It will be appreciated that in one or more alternative embodiments wherein the end effector uses a force created by vacuum suction or a magnet to hold the container, the end effector may not have any fingers.

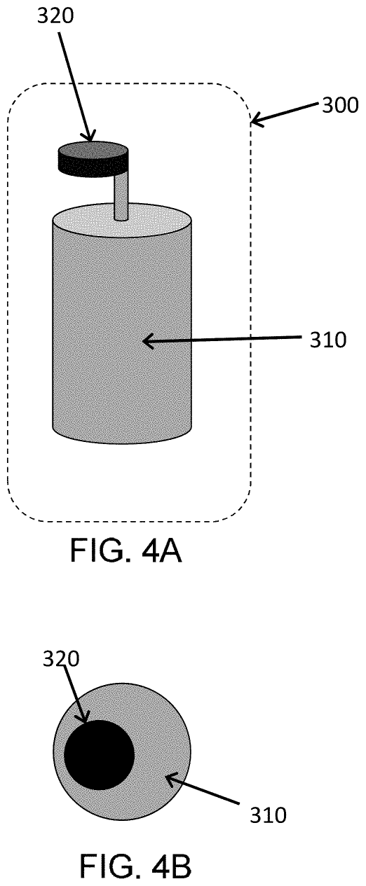

Now referring to FIGS. 4a and 4b, there are shown two views of an embodiment wherein the vibration generator 300 comprises a vibration motor.

In this embodiment, the vibration motor comprises an electric motor 310 having a rotating axis and a mass 320 eccentrically mounted on the rotating axis of the electric motor 310.

It will be appreciated that the electric motor 310 may be of various types. In one embodiment, the electric motor 310 is a DC motor. The skilled addressee will appreciate that various alternative embodiment may be possible for the electric motor 310.

In one non-limiting embodiment, the vibration generator 300 is a vibration motor and is manufactured by Precision Microdrives Limited.

As mentioned above, the vibration motor further comprises a mass 320. The mass 320 may be of various shape and size depending on a vibration to generate. In fact, the skilled addressee will appreciate that the centripetal force is proportional to the eccentric mass 320 while the frequency of the vibration generated is proportional to the rotating speed of the vibration motor.

While this has not been shown in FIG. 4, it will be appreciated by the skilled addressee that the vibration motor receives energy from a suitable energy source, such as a battery. It will be appreciated by the skilled addressee that the energy source may be fully integrated, or not, with the vibration motor.

As mentioned previously, it will be further appreciated that a controller, not shown, is operatively connected to the vibration generator 300 and is used for providing a controlling signal to the vibration generator 300. The vibration is generated by the vibration generator 300 in accordance with the vibration signal provided by the controller.

It will be appreciated that the controller may be operatively connected to the vibration generator 300 according to various embodiments. In one embodiment the controller is connected to the vibration generator 300 using a wired connection. In an alternative embodiment, the controller is connected to the vibration generator 300 using the wireless connection.

It will be appreciated that in one embodiment the vibration signal provided causes the vibration generator 300 to vibrate at a given frequency suitable for a dispensing operation to be performed if the vibration applied is used for assisting a dispensing operation.

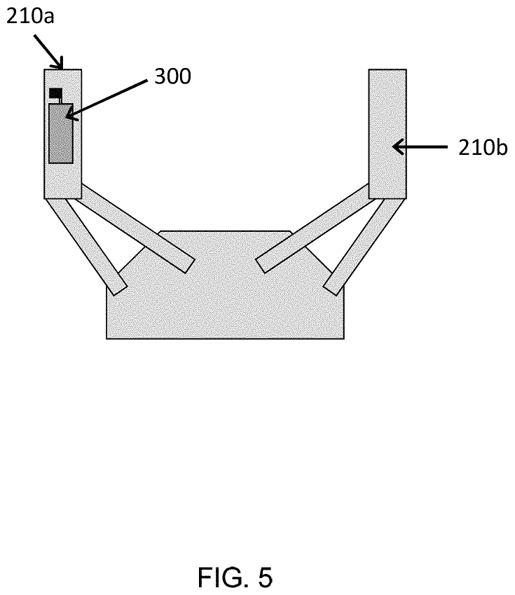

Now referring to FIG. 5, there is shown a first embodiment illustrating how the vibration motor 300 is integrated in the first finger 210a of the end effector 200.

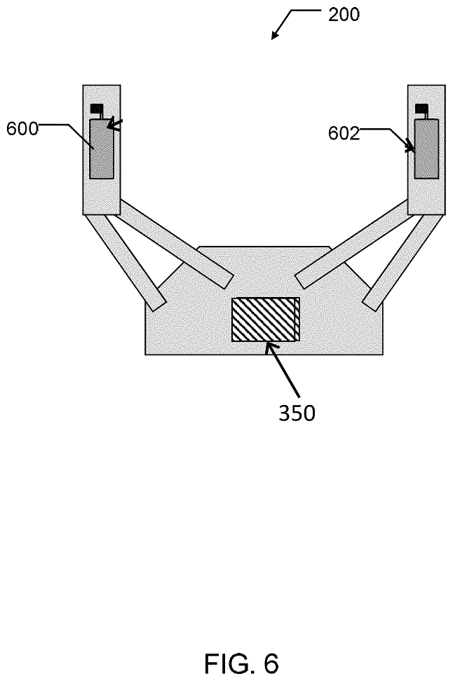

Now referring to FIG. 6, there is shown a second embodiment illustrating how two vibration motors, respectively 600 and 602, are integrated, each in a respective one of the first finger 210a and the second finger 210b of the end effector 200.

It will be also appreciated that a vibration sensor 350 is also provided in the embodiment disclosed in FIG. 6.

The vibration sensor 350 is adapted for sensing an ambient level of vibration. It will be appreciated that the vibration sensor 350 may be of various types.

In one embodiment the vibration sensor 350 is an accelerometer and is manufactured by TE Connectivity. In another embodiment, the vibration sensor 350 is a strain gauge and is manufactured by Omega Engineering. In another embodiment, the vibration sensor 350 is an Eddy-Current sensor and is manufactured by Micro-Epsilon.

More precisely, the vibration sensor 350 is operatively connected to the controller, not shown. It will be appreciated that the vibration sensor 350 may be operatively connected to the controller according to various embodiments. In one embodiment, the vibration sensor 350 is operatively connected to the controller using a wired connection. In an alternative embodiment, the vibration sensor 350 is operatively connected to the controller using a wireless connection.

The vibration sensor 350 provides a vibration sensor signal to the controller. The vibration sensor signal is indicative of a level of vibration detected by the vibration sensor 50. It will be appreciated that the controlling signal is generated using at least the vibration sensor signal.

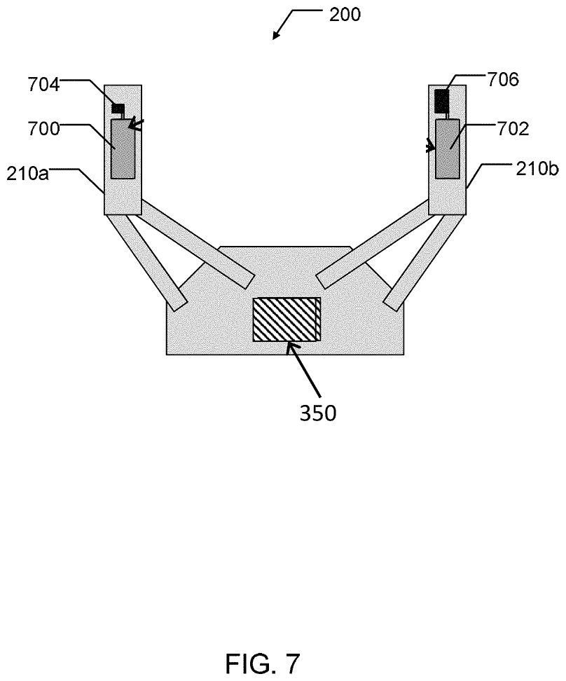

Now referring to FIG. 7, there is shown an embodiment illustrating a system for applying a vibration wherein the vibration generator comprises at least two vibration generating units. In this embodiment, each vibration generating unit generates a corresponding and different vibration.

It will be appreciated that the at least two vibration generating units may be mounted or not in different directions.

It will be further appreciated that the controlling signal provided by the controller comprises at least two corresponding vibration generating unit controlling signals for controlling each of the at least two corresponding vibration generating units accordingly. While in one embodiment the corresponding vibration generated by each of the at least two vibration generating units is similar, it will be appreciated that in another embodiment each corresponding vibration may be different.

More specifically, in this embodiment two vibration motors 700, 702 are integrated each in a respective one of the first finger 210a and the second finger 210b of the end effector 200.

In this specific embodiment, the two vibration motors 700, 702 are different. More precisely and as shown in FIG. 7, a vibration mass 704 of the first vibration motor 700 is different in size than a vibration mass 706 of the second vibration motor 702.

It will be appreciated that each of the first vibration motor 700 and the second vibration motor 702 will generate a corresponding vibration having a corresponding and different vibration amplitude.

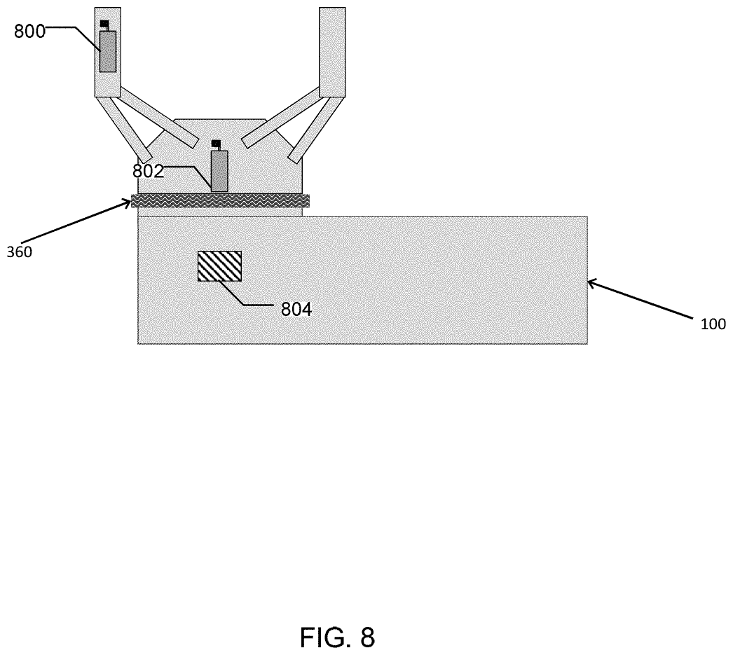

Now referring to FIG. 8, there is shown another embodiment illustrating a vibration motor 800 operatively coupled to an end effector and a second vibration motor 802 operatively coupled to a mechatronic manipulator at an operating distance from a container comprising a content, not shown, such that when the vibration motors 800, 802 are in operation, the vibration motors 800, 802 cause the container to vibrate accordingly.

In this embodiment, the second vibration motor 802 operatively coupled to the mechatronic manipulator is further away from the container and may be used for instance to cancel out the vibrations generated by the vibration motor 800 and prevent them from entering the mechatronic manipulator 100. It will be appreciated that the transmission of the vibrations may be further reduced with passive vibration isolation using a dampening element 360. It will be appreciated that the dampening element 360 may be of various types as known by the skilled addressee. In one embodiment, the dampening element 360 comprises an elastomer such as rubber. In another embodiment, the dampening element 360 uses mechanical or pneumatic isolators. The skilled addressee will appreciate that various alternative embodiments may be used for providing the dampening element 360. It will be further appreciated that in this embodiment a vibration sensor 804 is used for detecting a minimal vibration. It will be appreciated that the vibration sensor 804 may be operatively connected to the controller. In fact, it will be appreciated that the vibration sensor 804 may be operatively connected to the controller using various embodiments. In one embodiment, the vibration sensor 804 is operatively connected to the controller using a wired connection. In another embodiment, the vibration sensor 804 is operatively connected to the controller using a wireless connection. Moreover, it will be appreciated that the vibration sensor 804 may be of various types. In one embodiment the vibration sensor 804 is an accelerometer and is manufactured by TE Connectivity. In another embodiment, the vibration sensor 804 is a strain gauge and is manufactured by Omega Engineering. In another embodiment, the vibration sensor 804 is an Eddy-Current sensor and is manufactured by Micro-Epsilon.

While this has not been disclosed above, it will be appreciated that the system for applying a vibration to a container may further comprise a dispensing feedback device. The dispensing feedback device is operatively connected to the controller.

It will be appreciated that the dispensing feedback device may be operatively connected to the controller according to various embodiments. In one embodiment, the dispensing feedback device is operatively connected to the controller using a wired connection. In an alternative embodiment, the dispensing feedback device is operatively connected to the controller using a wireless connection.

Moreover, it will be appreciated that the dispensing feedback device may be of various types. It will be appreciated that the dispensing feedback device may be selected from a group consisting of a camera, a load cell and a torque sensor.

It will be appreciated that the dispensing feedback device is used for providing a signal indicative of a content dispensed. The controller may generate the controlling signal according to the dispensing operation to be performed as well as using the signal indicative of a content dispensed.

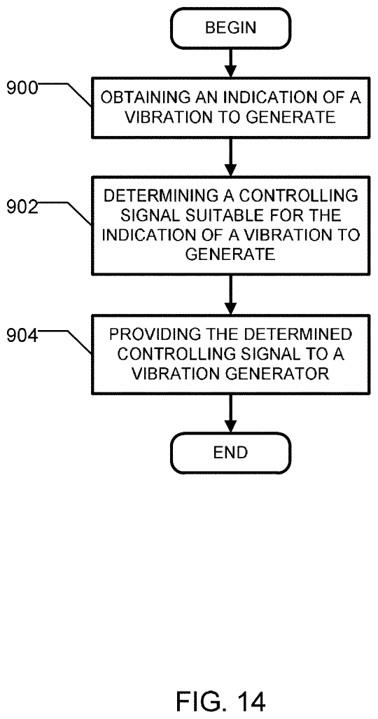

Now referring to FIG. 14, there is shown a method for applying a vibration on a container comprising a content.

According to processing step 900, an indication of a vibration to generate is obtained. It will be appreciated that the indication of a vibration to generate may be obtained according to various embodiments. In one embodiment, the indication of a vibration to generate is received by the controller. It will be appreciated that in one embodiment, the indication of a vibration to generate is provided by a processing unit. In one embodiment, the vibration generated is used for performing a dispensing operation and the indication of a vibration is suitable for the dispensing operation to perform.

According to processing step 902, a controlling signal suitable for the obtained indication of a vibration to generate is determined. It will be appreciated that the controlling signal is determined by the controller of the system for applying a vibration to a container. In one embodiment, the determining of the controlling signal suitable for the obtained dispensing operation to perform comprises accessing the lookup table with an indication of the dispensing operation to perform and obtaining a corresponding controlling signal.

According to processing step 904, the determined controlling signal is provided to a vibration generator operatively coupled to at least one of the end effector and the mechatronic manipulator at an operating distance from the container such that when the vibration generator is in operation, the vibration generator causes the container to vibrate accordingly.

In one embodiment the method further comprises obtaining a feedback indicative of a content dispensed and amending the controlling signal using the obtained feedback indicative of a content dispensed.

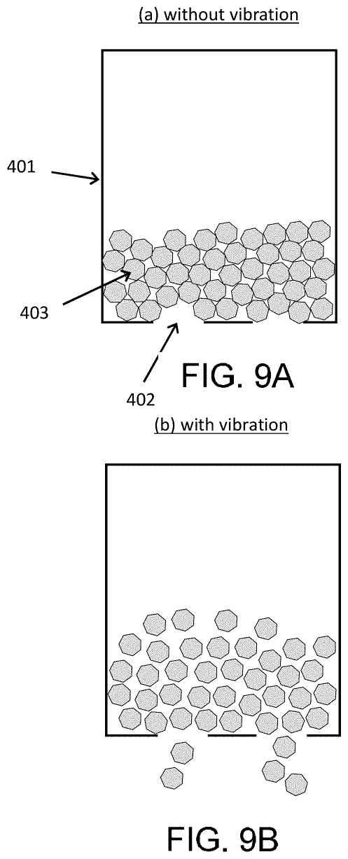

Now referring to FIG. 9a, there is shown an embodiment of a container 401 to be received by the end effector, not shown, and which comprises a content 403. It will be appreciated that the container 401 is a container having one or more small openings on one side. An embodiment of such container may be a container adapted for dispensing salt for instance Uline provides such containers (See https://www.uline.com/BL_757/Plastic-Spice-Jars). In this embodiment, the container 401 comprises a plurality of openings at a bottom thereof, an embodiment of which is opening 402. Each opening of the plurality of openings is sized and shaped for allowing a portion of the content 403 to leave the container 401 thanks to gravitation force. It will be appreciated by the skilled addressee that in this embodiment no vibration has been applied to the container 401. The content 403 is not capable of leaving the container 401 due to its size.

Now referring to FIG. 9b, it will be appreciated that a vibration has been applied to the container 401 using an embodiment of the system for applying a vibration to a container disclosed herein. As a result, at least one portion of the content 403 is capable of leaving the container 401, which is of great advantage.

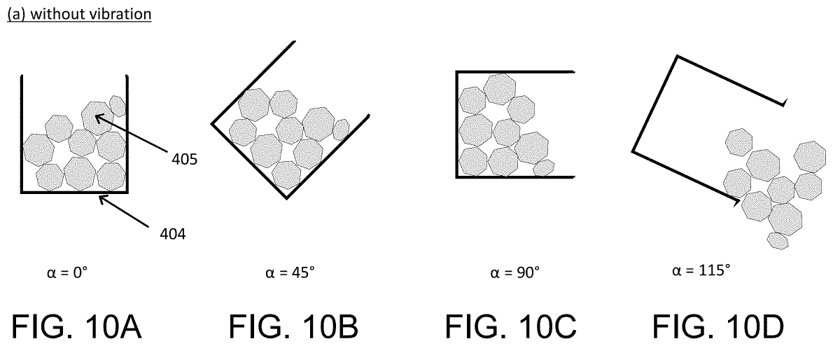

Now referring collectively to FIGS. 10a, b, c and d, there is illustrated throughout those figures a dispensing operation performed without an embodiment of the system for applying a vibration to a container disclosed herein. Each of FIGS. 10a, b, c and d illustrates a given angle of the dispensing sequence of a container 404 comprising a content 405. As mentioned previously, in this particular embodiment, no vibration is applied to the container. As a result, the dispensing of the content 405 is not precise. In other words it is controlled only by the angle.

The skilled addressee will appreciate that the efficiency of the dispensing is also dependent on the nature of the content 405. In particular, in the case where the content 405 is comprised of various elements of different size and shapes the dispensing may become highly complex and uneven.

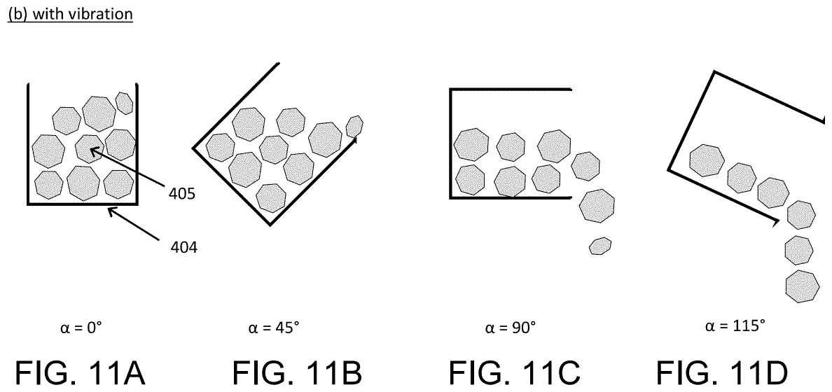

Now referring collectively to FIGS. 11a, b, c and d, there is illustrated a dispensing sequence wherein a vibration is applied to the container 404 comprising the content 405 using an embodiment of the system for applying a vibration to a container disclosed herein. The skilled addressee will appreciate that thanks to the vibration applied, the dispensing is more precise. In other terms, more control is available on an amount of content dispensed and or on a dispensing flow rate than in the embodiment wherein no vibration is applied which is of great advantage.

It will be appreciated that an embodiment of the system for applying a vibration to a container disclosed herein may be used for various other alternative applications.

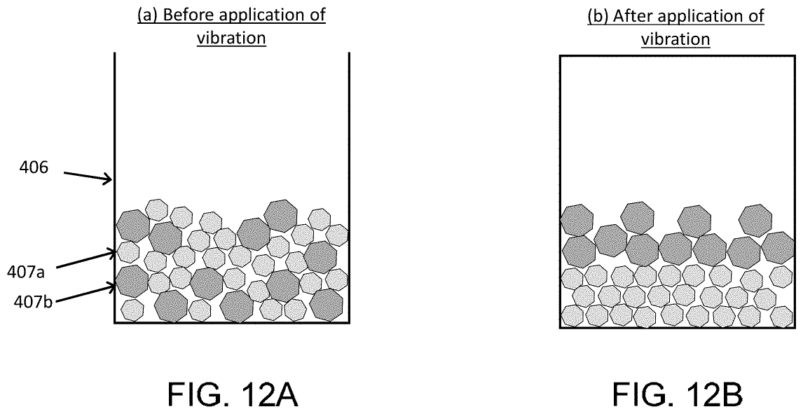

For instance and as illustrated in FIGS. 12a and 12b, an embodiment of the system for applying a vibration to a container disclosed herein may be used for generating a vibration used for performing a size separation of a granular matter comprised inside the container.

The granular matter may be comprised of elements of at least two types, such as of a first type 407a and of a second type 407b.

While before the applying of any vibration and as illustrated in FIG. 12a the elements of the first type 407a and the elements of the second type 407b are randomly mixed, it will be appreciated that after the applying of vibrations, using an embodiment of the system for applying a vibration to a container, and as shown in FIG. 12b, the content of the first type 407a is clearly separated from the content of the second type 407b.

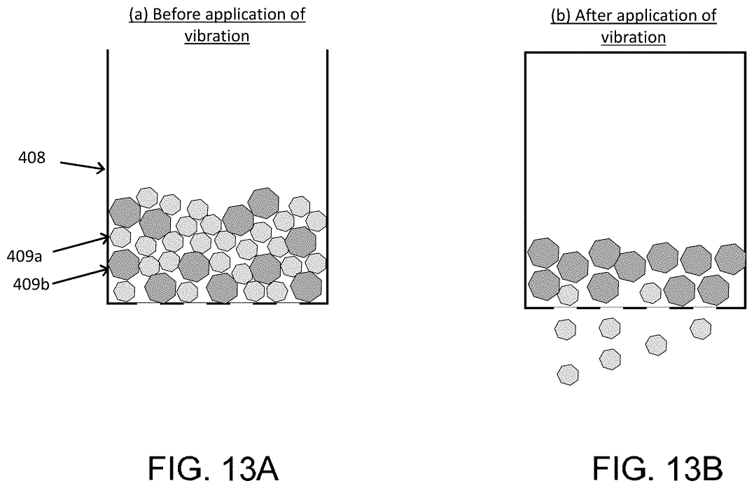

In another embodiment disclosed in FIGS. 13a and 13b, an embodiment of the system for applying a vibration to a container is used for performing a size screening of granular elements.

More precisely and in this embodiment, the container comprises a content of at least two types. A first type of content, of a smaller type, is content 409a while a second type of content, of a larger type, is content 409b. In this embodiment, the container is a type 3 container.

It will be appreciated that the container 408 further comprises a plurality of opening sized and shaped for enabling the content of the smaller type to leave the container 408 thanks to the gravitational force.

It will be appreciated that once the vibration is applied using an embodiment of the system for applying a vibration to a container, the content 409a of the smaller type is capable of leaving the container 408. The vibration may therefore be advantageously used for performing a size screening of granular matter.

The skilled addressee will appreciate that various alternative embodiments may be possible.

It will be appreciated that one or more embodiments of the system disclosed herein is of great advantage for various reasons.

An advantage of one or more embodiments of the method disclosed is that it enables a more precise dispensing of a content contained in a container when the method is used for dispensing the content of the container.

Another advantage of one or more embodiments of the method disclosed is that it enables a filtering of a content contained in a container when the content is comprised of a plurality of granular elements of various sizes.

Another advantage of one or more embodiments of the method disclosed is that it enables a precise and slower dispensing of a content contained in a container when the method is used for dispensing the content of the container.

Another advantage of one or more embodiments of the method disclosed is that it enables to start and stop the dispensing of a content contained in a container with openings on the bottom when the method is used for dispensing the content of the container.

Another advantage of one or more embodiments of the method disclosed is that it enables the sorting of a content contained in a container according to particle size when the content is comprised of a plurality of granular elements of various sizes.

Another advantage of one or more embodiments of the method disclosed herein is that it enables to achieve a more continuous flow rate enabling a greater predictability and control throughout the dispensing process.

It will be appreciated that there is also disclosed a computer readable medium comprising computer executable instructions which when executed causes a controller to perform a method for applying a vibration to a container comprising a content, the container being held by an end effector attached to a mechatronic manipulator, the method comprising obtaining an indication of a vibration to generate; determining a controlling signal suitable for the obtained indication of a vibration to generate and providing the determined controlling signal to a vibration generator operatively coupled to at least one of the end effector and the mechatronic manipulator at an operating distance from the container such that when said vibration generator is in operation, said vibration generator causes said container to vibrate accordingly.

Although the above description relates to a specific preferred embodiment as presently contemplated by the inventor, it will be understood that the invention in its broad aspect includes functional equivalents of the elements described herein.

1. A system for applying a vibration to a container comprising a content, said container held by an end effector attached to a mechatronic manipulator, the system comprising:
a vibration generator operatively coupled to at least one of the end effector and the mechatronic manipulator at an operating distance from the container such that when said vibration generator is in operation, said vibration generator causes said container to vibrate accordingly; and
a controller operatively connected to the vibration generator, said controller for generating and providing a controlling signal to said vibration generator.

2. The system as claimed in claim 1, wherein the applying of the vibration according to the controlling signal is used for performing a dispensing operation of at least one part of the content of the container.

3. The system as claimed in claim 2, wherein the dispensing operation to be performed is one of starting a dispensing of the content and dispensing the content according to a given flow rate.

4. The system as claimed in claim 2, wherein the vibration generator is selected from a group comprising at least one of a vibration motor, an ultrasonic motor, a piezo electric actuator and an ultrasonic transducer.

5. The system as claimed in claim 2, wherein the vibration generator comprises a vibration motor comprising a motor having a rotating axis and a mass eccentrically mounted on said rotating axis of said motor.

6. The system as claimed in claim 2, wherein the controlling signal causes said vibration generator to vibrate at a given vibrating frequency suitable for said dispensing operation to be performed.

7. The system as claimed in claim 6, wherein the controlling signal causes said vibration generator to vibrate at a given amplitude suitable for said given dispensing operation to be performed.

8. The system as claimed in claim 2, further comprising a vibration sensor operatively connected to the controller, said vibration sensor providing a vibration sensor signal to the controller, further wherein the controlling signal is generated using the vibration sensor signal and the dispensing operation to be performed.

9. The system as claimed in claim 2, wherein the vibration generator comprises at least two vibration generating units, each of the at least two vibration generating units generating a corresponding vibration; further wherein the controlling signal comprises at least two corresponding vibration generating unit controlling signals for controlling each of the at two corresponding vibration generating units accordingly.

10. The system as claimed in claim 9, further comprising a vibration sensor operatively connected to the controller, said vibration sensor providing a vibration sensor signal to the controller, further wherein the controlling signal is generated using the vibration sensor signal and the dispensing operation to be performed.

11. The system as claimed in claim 9, wherein each of the at least one corresponding vibration generating unit controlling signal causes the corresponding vibration generating unit to vibrate at a given vibrating frequency suitable for said dispensing operation to be performed.

12. The system as claimed in claim 9, each of the at least two corresponding vibration generating unit controlling signals causes the corresponding vibration generating unit to vibrate at a given amplitude suitable for said given dispensing operation to be performed.

13. The system as claimed in claim 2, wherein the vibration generator is mounted on the mechatronic manipulator at an end effector.

14. The system as claimed in claim 13, wherein the end effector is a robotic gripper.

15. The system as claimed in claim 13, wherein the end effector is a robotic gripper comprising at least one finger used for holding the container, wherein the vibration generator is mounted on a finger of the at least one finger.

16. The system as claimed in claim 2, wherein the controller comprises a lookup table comprising for each dispensing operation to be performed a corresponding controlling signal to provide, wherein the generating of the controlling signal comprises accessing the lookup table.

17. The system as claimed in claim 2, further comprising a dispensing feedback device operatively connected to the controller, the dispensing feedback device providing a signal indicative of a content dispensed, the controller generating the controlling signal according to the dispensing operation to be performed and using the signal indicative of a content dispensed.

18. The system as claimed in claim 17, wherein the dispensing feedback device is selected from a group consisting of a camera, a load cell and a torque sensor.

19. The system as claimed in claim 9, wherein at least two of the at least two vibration generating units are mounted in different directions.

20. A method for applying a vibration to a container comprising a content, said container being held by an end effector attached to a mechatronic manipulator, the method comprising;
obtaining an indication of a vibration to generate;
determining a controlling signal suitable for the obtained indication of a vibration to generate;
providing the determined controlling signal to a vibration generator operatively coupled to at least one of the end effector and the mechatronic manipulator at an operating distance from the container such that when said vibration generator is in operation, said vibration generator causes said container to vibrate accordingly.

21. The method as claimed in claim 20, wherein said vibration is used for performing a dispensing operation, further wherein said indication of a vibration is suitable for the dispensing operation to perform.

22. The method as claimed in claim 21, further comprising obtaining a feedback indicative of a content dispensed, the method further comprising amending the controlling signal using the obtained feedback indicative of a content dispensed.

23. The method as claimed in claim 21, wherein the determining of the controlling signal suitable for the obtained dispensing operation to perform comprises accessing a lookup table with an indication of the dispensing operation to perform and obtaining a corresponding controlling signal.

24. A mechatronic manipulator comprising the system as claimed in claim 1.

25. A computer readable medium comprising computer executable instructions which when executed causes a processing unit to perform the method as claimed in claim 20.
